(19) United States
(12) Patent Application Publication
(10) Pub. No.: US 2006/0039576 A1
(43) Pub. Date: Feb. 23, 2006

(54) Method and device for improving heaing aid fitting

(76) Inventors: Robert Roithinger, Valentin (AT); Jes Olsen, Hellerup (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/541,439

(22) PCT Filed: Jan. 6, 2004
(86) PCT No.: PCT/DK04/00003

§ 371 Date: Jul. 5, 2005

(30) Foreign Application Priority Data
Jan. 6, 2003 (PA) 2003-00006

(51) Int. Cl. H04R 25/00

(52) U.S. Cl. 381/312

(57) ABSTRACT

A method and apparatus for improving a hearing aid fitting situation by means of providing a higher degree of user involvement in the fitting process, the method including simultaneous visualizing for a patient and/or a hearing professional the actual input and the setting of the hearing aid transfer function or the hearing threshold of the individual.

### AREA OF THE INVENTION

The invention relates to the field of hearing aids and particularly to the fitting of hearing aids to the need of hearing-impaired individuals.

### BACKGROUND OF THE INVENTION

Usually the fitting of a hearing aid involves the adjustment of the transfer characteristics of the hearing aid signal path to the actual hearing loss of the individual. The hearing loss is usually determined in an audiometry test, which is well known in the field. Having made a first setting of the hearing aid signal path according to the actual hearing loss, a fine-tuning of the hearing aid transfer function is most often performed. This usually involves the presentation of test sounds, which may be presented by the hearing aid professional or as a part of the fitting software program, where the sounds are presented to the individual either alone or together with a visualization of the situation from which the sound originates. The hearing professional must in this process rely completely on the response from the hearing impaired in order to evaluate the actual settings. This may be a cumbersome process, especially in connection with first time hearing aid users.

Moreover in the fitting situation a need exists for increased user involvement in the actual technical fitting process, which is desirous in order to make the individual comfortable and feel secure about the situation and in order to achieve the best possible result in the fitting process.

The objective of the present invention is to provide a method, a system, a device and a software, which may provide improvement to the fitting situation in respect of the above mentioned shortcomings.

### SUMMARY OF THE INVENTION

According to the invention the first aspect of the objective is achieved by means of the method defined in claim 1.

By visualizing the input and/or the hearing aid transfer function relative to the hearing threshold of the individual, the hearing professional will be able to evaluate whether the hearing impaired should be able to recognize the input or not. Furthermore by simulating how the hearing aid in its actual setting will process the measured input and visualize this into a simulation or measurement of the patients residual dynamic range, the hearing care professional can evaluate whether the hearing impaired should be able to tolerate the input or not. Furthermore by visualizing for the hearing impaired individual the input and the hearing aid transfer function or the hearing threshold of this individual, he or she will obviously to a significantly higher degree be involved in the fitting process and actually be able to see, real-time or with a insignificant delay, what can and cannot be heard, and hereby enter into a more active dialog with the hearing aid professional during the fitting process. This inherently results in a fitting result that is improved compared to the method hitherto used. Hence there is obviously an improvement in the fitting situation and furthermore the possibility of reducing the time consumption in the fitting process while at the same time achieving the same or an even better result of the fitting.

The dependent claims 2-4 depict preferred embodiments of the method.

When at least two displays are provided for display of information to a patient and to a hearing professional the patient may be involved in the fitting process in a convenient manner. Preferably a selected information is provided at the patient screen to avoid confusion.

The display update rate is preferably less than 1 second, preferably more than 0.1 second and less than 0.4 second. Hereby both the patient and the hearing professional may obtain the necessary information in a close to real-time manner.

Further the actual microphone input, the amplification characteristics, the simulated output, the microphone output, the UCL, the MCL or the MCR could be displayed in the same X-Y display. This add further information to the fitting situation.

According to the invention the second aspect of the objective is achieved by means of the system as defined in claim 5.

By such system the same advantages as mentioned in connection with the method may be achieved.

Dependent claims 6-8 depict advantageous embodiments. The advantages correspond to those in connection with claims 2-4.

According to the invention the third aspect of the objective is achieved by means of the device as defined in claim 9.

By such device as a part of a system as described above for performing the method according to the invention the same advantages as mentioned in connection with the method may be achieved.

Advantageous embodiments are depicted in claims 10-12. The advantages correspond to those in connection with claims 24.

According to the invention the fourth aspect of the objective is achieved by means of the software as defined in claim 13.

By such software as a part of a system as described above for performing the method according to the invention the same advantages as mentioned in connection with the method may be achieved.

Advantageous embodiments are defined in the dependent claims. The advantages correspond to those in connection with claims 2-4.

The invention is described more detailed in the following description of a preferred embodiment with reference to the drawing.

### BRIEF DESCRIPTION OF THE DRAWINGS

FIG. 1 depicts a system comprising a hearing aid and a fitting device with screen where a hearing threshold is displayed and where simultaneously the level of a hearing aid output signal is displayed;

FIG. 2 is a more detailed presentation of a screen where the output is shown.

### DESCRIPTION OF A PREFERRED EMBODIMENT

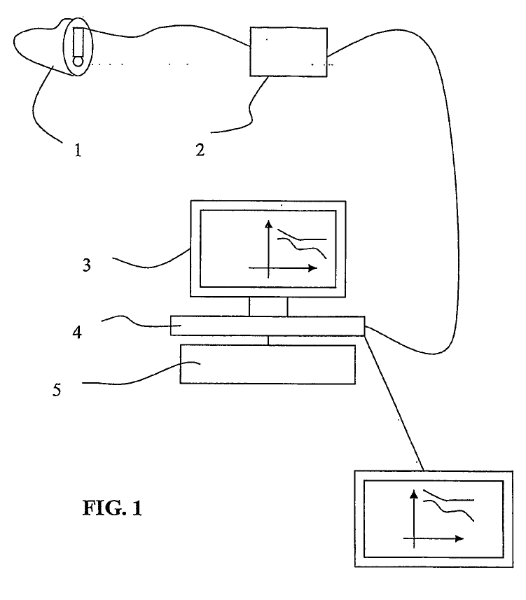

From FIG. 1 the system according to the invention appears in a schematic form. The system comprises a hearing aid, which is connected to a fitting device. The fitting device comprises a hearing aid interface unit and a computer with a screen. The computer has in its memory a dedicated fitting software allowing adjustment of parameters in the hearing aid controlled by the computer or the hearing professional handling the computer.

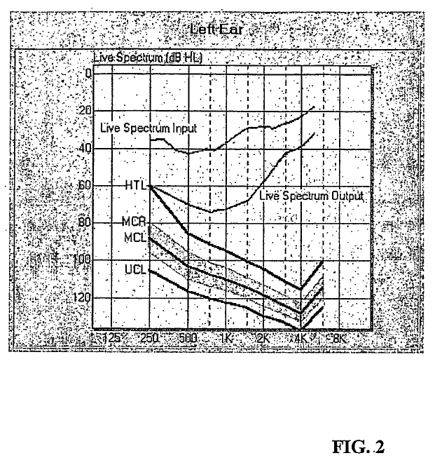

From FIG. 2 the screen display appears where the hearing loss of the patient is displayed and where simultaneous the input, the amplification characteristics, the simulated output and/or the microphone output is displayed in the same coordinate system. Combinations of two or more of these parameters may be chosen for simultaneous display.

For the purpose of facilitating the fitting process a patient display could be provided, where this in order to avoid misunderstanding could display to the patient only the data relevant for the patient and where the hearing aid professional could have a second display with full display of all data relevant to the fitting process.

1. A method for providing improvement to a hearing aid fitting situation where the method comprises simultaneous visualizing an output of the hearing aid based on a calculated or measured input to the microphone and a calculated or measured hearing threshold of the patient.

2. A method according to claim 1, where at least two displays are provided for display of information to a patient and to a hearing professional.

3. A method according to claim 2, where a selected information is provided by the second screen for the patient, where the selected information is defined by the hearing professional.

4. A system according to claim 2, where the display update rate is less than 1 second.

5. A system according to claim 4, where further the actual microphone input, the amplification characteristics, the simulated output, the microphone output, the UCL, the MCL or the MCR is displayed in the same X-Y display.

6. A system for performing the method according to claim 1, comprising a hearing aid and a fitting hardware comprising suitable software, where the hearing aid is corresponding with the hardware, where the hardware comprises a screen for display of data in connection with the fitting and where on the screen a display of a hearing threshold as a function of the frequency is provided, where the hearing aid provides to the hardware data relating to the actual input to the microphone of the hearing aid, where simultaneous or with a small delay these data relating to the actual input are displayed directly or in a processed form in the same display as the hearing threshold.

7. A system according to claim 6, where at least two displays are provided for display of information to a patient and to a hearing professional.

8. A system according to claim 7, adapted for displaying a selected information to the second screen for the patient, where the selected information is defined by the hearing professional.

9. A system according to claim 7, where the screen update rate is less than 1 second.

10. A system according to claim 9, where further the actual microphone input, the amplification characteristics, the simulated output, the microphone output, the UCL, the MCL or the MCR is displayed in the same X-Y display.

11. A hearing aid fitting device comprising a fitting hardware having suitable software, where the hearing aid is adapted for being connected with the hardware, where the hardware comprises a screen for display of data in connection with the fitting and where on the screen a display of the hearing threshold as a function of the frequency is provided, where the fitting device upon receiving data from a hearing aid data relating to the actual input to the hearing aid, is adapted for displaying simultaneous or with a small delay these data relating to the actual input are displayed directly or in a processed form in the same display as the hearing threshold.

12. A fitting device according to claim 11, where at least two displays are provided for display of information to a patient and to a hearing professional.

13. A fitting device according to claim 12, which is adapted for displaying a selected information to the second screen for the patient, where the selected information is defined by the hearing professional.

14. A fitting device according to claim 12, where the screen update rate is less than 1 second.

15. A fitting device according to claim 14, where further the actual microphone input, the amplification characteristics, the simulated output, the microphone output, the UCL, the MCL or the MCR is displayed in the same display.

16. A fitting software for a computer comprising a screen for display of data in connection with the fitting and where fitting software is adapted for providing on the screen a display of a hearing threshold as a function of the frequency is provided, where the fitting software upon receiving data from a hearing aid data relating to the actual input to the hearing aid, is adapted for providing a display simultaneous or with a small delay of these data relating to the actual input directly or in a processed form in the same display as the hearing threshold.

17. A fitting software according to claim 16, where means are provided for driving at least two displays for display of information to a patient and to a hearing professional.

18. A fitting software according to claim 17, where the software is adapted for displaying a selected information to the second screen for the patient, where the selected information preferably is defined by the hearing professional.

19. A fitting software according to claim 17, where the screen update rate is more than 0.1 second and less than 0.4 second.

20. A fitting software according to claim 16, where software is stored on a storage medium in a computer or for use in a computer.

21. A fitting software according to claim 20, further adapted to display the actual microphone input, the amplification characteristics, the simulated output, the microphone output, the UCL, the MCL or the MCR in the same display.
